(19) United States
(12) Patent Application Publication
(10) Pub. No.: US 2016/0125388 A1
(43) Pub. Date: May 5, 2016

(54) OFF-LINE GUIDING AND CONFIRMATION DEVICE AND METHOD FOR SUPPORTING MOBILE PAYMENT

(71) Applicant: SHANGHAI RUIXIANG INFORMATION TECHNOLOGY CO., LTD., Shanghai (CN)

(72) Inventors: Peng Gao, Shanghai (CN); Bowen ZHANG, Shanghai (CN); Liangjian GENG, Shanghai (CN)

(21) Appl. No.: 14/892,583

(22) PCT Filed: Mar. 5, 2014
(86) PCT No.: PCT/CN2014/000200

§ 371 Date: Nov. 20, 2015

(30) Foreign Application Priority Data
Jan. 20, 2014 (CN) 201410025034.6

(51) Int. Cl. G06Q 20/32; G06Q 20/42; G06Q 20/08

(52) U.S. Cl. CPC G06Q 20/3276; G06Q 20/0855; G06Q 20/42; G06Q 2220/00

(57) ABSTRACT

The present invention discloses an offline payment guidance and confirmation device for supporting mobile payments, comprising: a display module, a storage module, a keyboard module, one or more encryption/decryption module(s), a power module, an input/output module, a main panel and a battery module, all connecting to an information processing module, wherein said one or more encryption/decryption modules can be exchangeable, and wherein said input/output module can be connected to any of the following peripheral devices by means of wired and/or wireless connections: a Quick-Response (QR) barcode reading device, a barcode reading device, a printing device, a voice recognition device, and an NFC recognition device. The present invention also discloses an offline payment guidance and confirmation method for supporting mobile payments. The present invention solves a deficiency of must maintaining both parties' devices online in the traditional dealing process, and the invention is low cost, safe and easy to use.

### TECHNOLOGY FIELD

This invention concerns with mobile Internet technology, particularly an offline payment guidance and confirmation device and method in supporting mobile payment.

### BACKGROUND OF THE INVENTION

Cellphone payments are also known as mobile payments, which is a type of services enabling mobile users to use their mobile terminals, usually being cellphone, to proceed with checkout payments for consumed merchandises or services. The basic principle of mobile payments is to establish a corresponding one-to-one relationship between a payment software and a user's personal bankcard account; the user, under the instructions of the mobile payment software, completes payment requests through the network. Because it is possible for customers to present false payment success information to merchants, the merchants must independently receive the user's payment success information and complete sales through the network. Currently, cellphone payments have the following deficiencies:

1. Both parties must maintain their equipment connected to the Internet at the same time during the transaction, and must confirm trading payments online. In a case when only the customer completes the payment but errors occur with the merchant's network equipment, a final trading confirmation cannot be accomplished, resulting in transaction disputes.

2. Trading information floats over the Internet, resulting in weak data security and lack of any necessary security protection measures. Therefore, the information can be easily taken.

3. Online trading information can include specific sales data of the merchant. Any leak of this information can cause leakage of the merchant's trade secrets, benefiting the merchant's industrial competitors.

4. Another issue involves a case when customers have to complete their transactions at a cashier counter, where it can cause long waiting lines during peak hours and can affect the a consumers' shopping experiences.

### SUMMARY OF THE INVENTION

The purpose of the present invention is to fill the aforementioned various deficiencies in the prior arts by providing an offline guidance and confirmation device and method of supporting mobile payments.

In realizing the aforementioned purpose, the present invention provides an offline payment guidance and confirmation device for supporting mobile payments, comprising: a display module, a storage module, a keyboard module, one or more encryption/decryption modules, a power module, an input/output module, a main panel and a battery module, all connecting with an information processing module.

The one or more encryption/decryption modules can be exchangeable.

The input/output module can be connected to peripheral equipment, through wired and/or wireless connection(s), from a group of peripheral devices consist of a Quick-Response barcode recognition device, a bar code recognition device, a printing device, a voice recognition device, and an NFC recognition device.

Specifically, any publically known solutions in existing technologies can be applied to the information processing module, the Quick-Response barcode recognition device, the bar code recognition device, the printing device, the voice recognition device, and the NFC recognition device described under this invention. The aforementioned publically known technical solutions are already acknowledged by the persons in the art; therefore, they are not repeated herein.

Based on the aforementioned offline payment guidance and confirmation device supporting mobile payment, an offline method supporting mobile payments is provided, comprising the steps of:

101. after a consumer's selection of certain merchandise(s) and/or acceptance of certain service(s) provided by merchant(s), the merchant(s) inputting information of a transaction bill number and a transaction amount via said keyboard module of the payment guidance and confirmation device;

102. an information processing module receiving the transaction bill number and the transaction amount of step 101 inputted via said keyboard module together with other trading information, which specifically includes: a leading string of a payment service provider, a device identification number, a merchant's collecting account number, a trading time, a trading confirmation code, being transferred to said encryption/decryption module for encryption;

103. said information processing module generating a Quick-Response barcode, using existing technologies, from the encrypted information and displaying this Quick-Response barcode via said display module;

104. the consumer scanning the Quick-Response barcode produced by the merchant's payment guidance and confirmation device via a mobile smart terminal with a client software having a function of Quick-Response barcode scanning, wherein the client software includes mobile client software of various payment service providers;

105. the client software with the function of Quick-Response barcode scanning uploading the trading information to a payment platform to request a payment;

106. the payment platform processing the payment request, proceeding with decrypting the trading confirmation code and requiring the consumer to confirm the payment amount and relevant information, and then entering a password;

107. the consumer confirming the payment amount and the relevant information, and then reentering the password to confirm the payment;

108. the payment platform verifying the password entered by the consumer, if the verification is successful, executing step 109, if it is unsuccessful, notifying the consumer to reenter the password;

109. the mobile payment platform sending an electronic receipt of successful trading to the consumer, including returning a decrypted trading confirmation code;

110. the merchant inputting, via said keyboard module of the payment guidance and confirmation device, the decrypted trading confirmation code returned at the costumer's receipt of the successful trading;

111. said information processing module verifying whether the trading confirmation code is correctly decrypted, if correct, displaying the transaction is successful; if incorrect, reminding to reenter trading confirmation code.

Compared with the existing technologies, the present invention has obviously advantageous.

Firstly, it is not necessary for the devices of two parties involved in the transaction to be connected to the Internet at the same time. There is only a need for the mobile terminal of the customer to be connected to the internet to complete payments and to acquire returned confirmation codes after decryptions, i.e. transactions can be completed by an offline mobile terminal of the merchant. The confirmation can be completed at the offline mobile terminal of the merchant, which can solve any disputes regarding any errors appeared on the merchant's device, which consequently cause the transaction to fail.

Secondly, the transaction request information obtained by the customer from the merchant's mobile terminal is encrypted data and therefore, more secure and more reliable for network transformation, which ensures the security of offline transaction confirmation. At the same time, the online trading information doesn't have to include any specific sales information of the merchant, only the verification of the merchant and transaction bill numbers, which avoids nay loss caused by the leakage of merchant's trade secrets.

At last, this invention can solve the problem of long waiting in line for to a concentrated checkout arrangement by transforming the concentrated checkout to a distributed checkout.

### BRIEF DESCRIPTION OF THE DRAWINGS

FIG. 1 is an exemplary diagram illustrating the hardware structure of the invention;

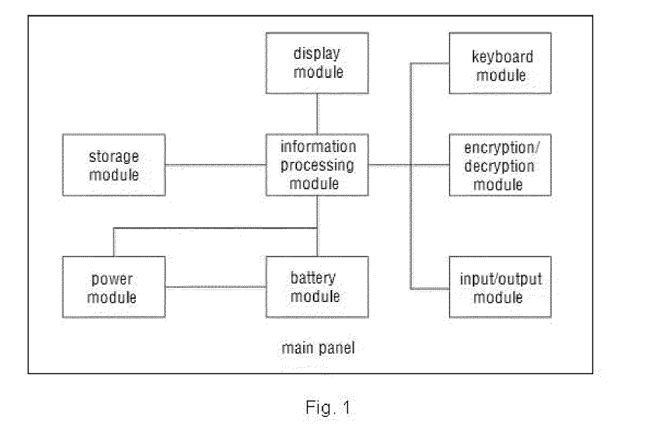

FIG. 2 is an exemplary diagram illustrating the outlook of the invention;

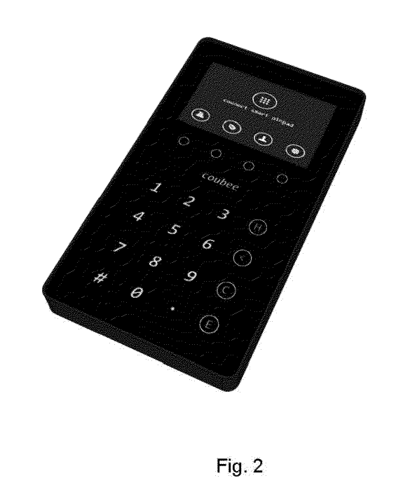

FIG. 3 is an exemplary circuit diagram of the motherboard of the invention;

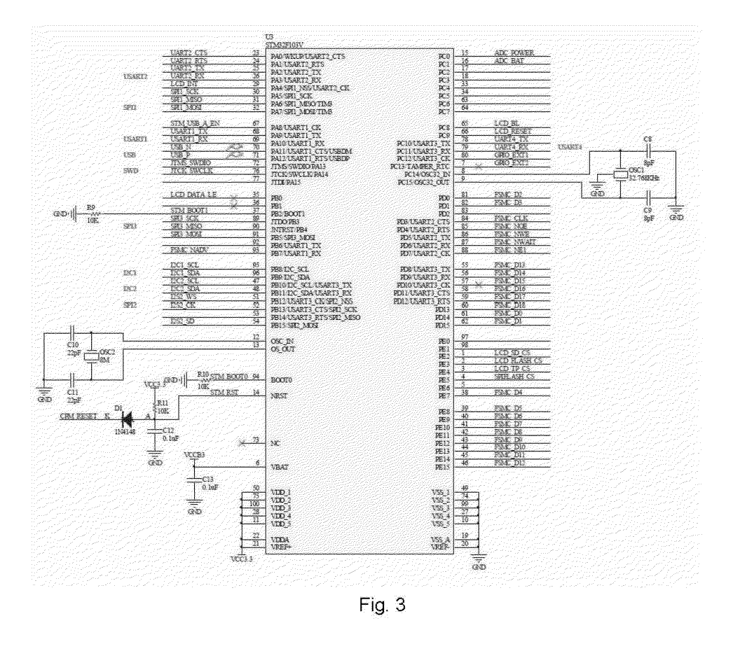

FIG. 4 is a flowchart diagram of the method of this invention.

### DESCRIPTION OF THE PREFERRED EMBODIMENT

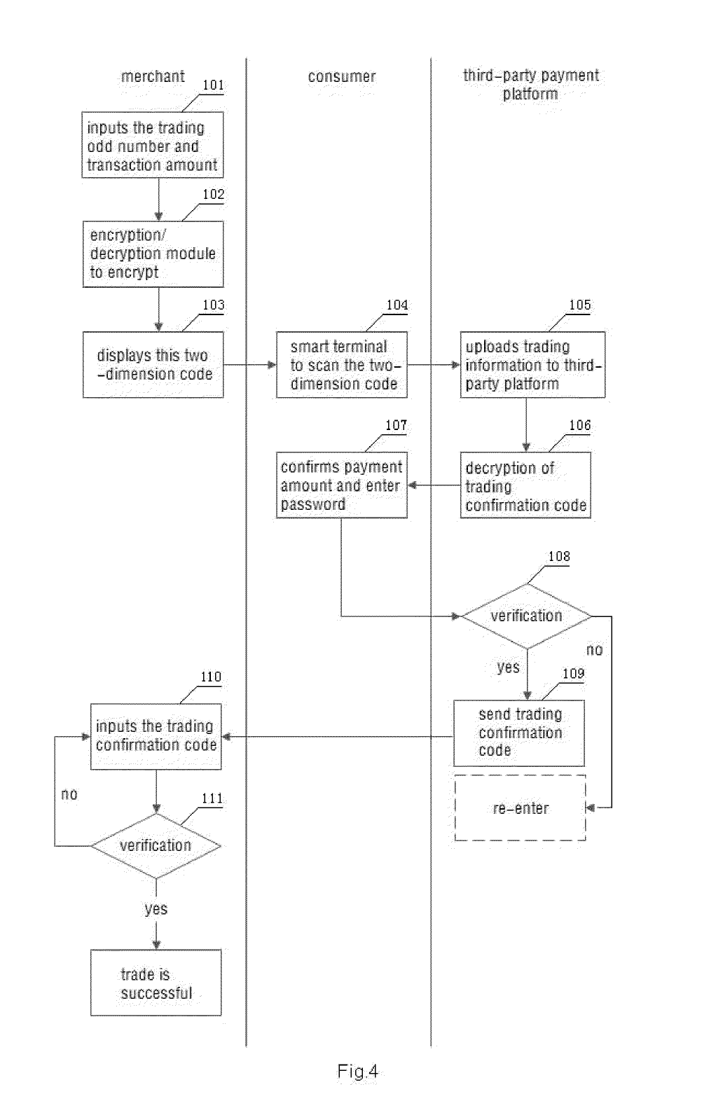

The present invention is discussed in details with reference to FIG. 4 and embodiments.

### Embodiment 1

The present invention is implemented in a department store to realize a counter checkout process with Alipay Mobile Wallet, avoiding waiting in line at a cashier.

101. In a department store in Beijing, which supports payments with cellphone Alipay Wallets, consumer A at a clothing counter picks a jacket, and then requests a payment with an Alipay Mobile Wallet. A sales representative inputs a transaction bill number 001 and a payment amount ¥500 via a payment guidance and confirmation device;

102. the payment guidance and confirmation device encrypts the transaction bill number 001, the transaction amount of ¥500 inputted by the sales representative along with other preset information, including: a device identification number, a merchant's Alipay account number, a trading time, a trading confirmation code;

103. the payment guidance and confirmation device displays a Quick-Response barcode on its display module, and the transaction amount of ¥500;

104. consumer A gets his smart cellphone, chooses a Quick-Response barcode scanning function with the Alipay Mobile Wallet on his cellphone to scan the Quick-Response barcode produced by the merchant's payment guidance and confirmation device;

105. the information acquired by scanning is transferred via the consumer's cellphone to an Alipay payment platform to request for a payment;

106. after the Alipay processes and decrypts the payment request, it returns response information to the client interface of the Alipay Mobile Wallet of the consumer's cellphone. On a screen page, it displays the request payment amount of ¥500 for the transaction, and a payment location, a transaction bill number, a payment time etc., and ask for entering an Alipay password;

107. the consumer confirms the payment amount with the cellphone , then enters the password xxxxxx, and clicks to confirm a submission;

108. the Alipay verifies the responded payment passwords xxxxxx submitted by the consumer;

109. when successfully verified, the Alipay returns an electronic receipt of successful payment to the consumer's cellphone which displays a notice of successful payment and a decrypted digital trading confirmation code;

110. the sales representative inputs the trading confirmation code returned to the consumer's cellphone in step 109 to said guidance and confirmation device for verification;

111. the payment guidance and confirmation device displays a successful payment notice on its screen after verifications, and the sales representative hands the jacket to consumer A, a purchase transaction is completed successfully.

### Embodiment 2

The present invention is implemented in an ordinary retailer to realize a payment with a cellphone wallet.

101. in a chain store selling sports goods, which supports Wechat payment, consumer B is purchasing a set of skiing equipment worth ¥2500, and requests a payment with Wechat. A sales representative inputs a transaction bill number 002 and a payment amount of ¥2500;

102. the payment guidance and confirmation device encrypts the transaction bill number 002 and the transaction amount of ¥2500 inputted by the sales representative along with other preset information, including: a device identification number, a merchant's Alipay account number, a trading time, a trading confirmation code;

103. the payment guidance and confirmation device displays the Quick-Response barcode on its display module, and the transaction amount of ¥2500;

104. consumer B gets his smart cellphone, chooses a Quick-Response barcode scanning function with the Wechat client software on his cellphone to scan the Quick-Response barcode produced by the merchant's payment guidance and confirmation device;

105. the information acquired by scanning is transferred via the consumer's cellphone to Wechat to request for a payment;

106. after the Wechat processes and decrypts the payment request, it returns response information to the Wechat payment page on the consumer's cellphone which displays the request payment amount of ¥2500 for the transaction, and a payment location, a transaction bill number, a payment time etc., and asks for entering a payment password;

107. the consumer confirms the payment amount with the cellphone, then enters the password xxxxxx, and clicks to confirm a submission;

108. the Wechat verifies the responded payment password xxxxxx submitted by the consumer;

109. when successfully verified, the Wechat returns an electronic receipt of successful payment to the consumer's cellphone which displays a notice of successful payment and a decrypted digital trading confirmation code;

110. the sales representative inputs the trading confirmation code returned to the consumer's cellphone in step 109 to said guidance and confirmation device;

111. the payment guidance and confirmation device displays a payment successful notice on its screen after verifications, and the sales representative hands the set of skiing equipment to consumer B.

### Embodiment 3

The present invention is implemented in restaurant to realize a checkout payment over a dinning counter.

101. in a steakhouse chain store, which supports 99bill Checkout, consumer C consumed an amount of ¥680, and requests a checkout with 99bill. A sales representative inputs a transaction bill number 011029 and a payment amount of ¥680;

102. the payment guidance and confirmation device encrypts the transaction bill number 011029 and the transaction amount of ¥680 inputted by the sales representative along with other preset information, including: a device identification number, a merchant's 99bill account number, a transaction time, a transaction confirmation code;

103. the payment guidance and confirmation device displays the Quick-Response barcode on its display, and the transaction amount of ¥680;

104. consumer C gets his smart cellphone, chooses a Quick-Response barcode scanning function of the 99bill on his cellphone to scan the Quick-Response barcode produced by the merchant's payment guidance and confirmation device;

105. the information acquired by scanning is transferred via the consumer C's cellphone to 99bill to request for a payment;

106. after the 99bill processes and decrypts the payment request, it returns with response information to the 99bill payment page on the consumer's cellphone which displays the request payment amount of ¥680 for the transaction, and a payment location, a transaction bill number, a payment time etc., and asks for entering a payment password;

107. the consumer confirms the payment amount with the cellphone, then enters the password xxxxxx, and clicks to confirm a submission;

108. the 99bill verifies the responded payment password xxxxxx submitted by the consumer;

109. when successfully verified, the 99bill returns an electronic receipt of successful payment to the consumer's cellphone which displays a notice of successful payment and a decrypted digital trading confirmation code;

110. the sales representative inputs the trading confirmation code returned to the consumer's cellphone in step 109 to said guidance and confirmation device;

111. the payment guidance and confirmation device displays a payment successful notice on its screen after verification, and checkout process is completed.

It should be understood that the present invention is not limited to the descriptions herein, and this invention is not limited to the particular forms described in the embodiments. An ordinary person in the art should understand that the present invention is to cover all modifications, variations, amendments or anternatives within the substantive scope of this invention.

We claim:

1. An offline payment guidance and confirmation device for supporting mobile payments, comprising:
a display module, a storage module, a keyboard module, one or more encryption/decryption module(s), a power module, an input/output (I/O) module, a motherboard and a battery module, all connecting with an information processing module.

2. The device of claim 1, wherein said one or more encryption/decryption modules are exchangeable.

3. The device of claim 1, wherein said input/output module is connected to the following peripheral equipment through wired and/or wireless connection(s): a Quick-Response barcode recognition device, a bar code recognition device, a printing device, a voice recognition device, and an NFC recognition device.

4. An offline method supporting mobile payments comprising the steps of:
101. after a consumer's selection of certain merchandise(s) and/or acceptance of certain service(s) provided by merchant(s), the merchant(s) inputting information of a transaction bill number and a transaction amount via said keyboard module of the payment guidance and confirmation device;
102. an information processing module receiving the transaction bill number and the transaction amount of step 101 inputted via said keyboard module together with other trading information, which specifically includes: a leading string of a payment service provider, a device identification number, a merchant's collecting account number, a trading time a trading confirmation code, being transferred to said encryption/decryption module for encryption;
103. said information processing module generating a Quick-Response barcode, using existing technologies, from the encrypted information and displaying this Quick-Response barcode via said display module;
104. the consumer scanning the Quick-Response barcode produced by the merchant's payment guidance and confirmation device via a mobile smart terminal with a client software having a function of Quick-Response barcode scanning, wherein the client software includes mobile client software of various payment service providers;
105. the client software with the function of Quick-Response barcode scanning uploading the trading information to a payment platform to request a payment;
106. the payment platform processing the payment request, proceeding with decrypting the trading confirmation code and requiring the consumer to confirm the payment amount and relevant information, and then entering a password;
107. the consumer confirming the payment amount and the relevant information, and then reentering the password to confirm the payment;
108. the payment platform verifying the password entered by the consumer, if the verification is successful, executing step 109, if it is unsuccessful, notifying the consumer to reenter the password;
109. the mobile payment platform sending an electronic receipt of successful trading to the consumer, including returning a decrypted trading confirmation code;
110. the merchant inputting, via said keyboard module of the payment guidance and confirmation device, the decrypted trading confirmation code returned at the costumer's receipt of the successful trading;
111. said information processing module verifying whether the trading confirmation code is correctly decrypted, if correct, displaying the transaction is successful; if incorrect, reminding to reenter trading confirmation code.
